(19) United States
(12) Patent Application Publication
(10) Pub. No.: US 2017/0134178 A1
(43) Pub. Date: May 11, 2017

(54) Charging Method, Charging Device, and Charging System

(71) Applicant: Huawei Technologies Co., Ltd., Shenzhen (CN)

(72) Inventor: Enfeng Yang, Nanjing (CN)

(21) Appl. No.: 15/412,737

(22) Filed: Jan. 23, 2017

Related U.S. Application Data
(63) Continuation of application No. PCT/CN2015/080679, filed on Jun. 3, 2015.

(30) Foreign Application Priority Data
Nov. 17, 2014 (CN) 201410654552.4

(51) Int. Cl. H04L 12/14; H04W 4/24; H04M 15/00

(52) U.S. Cl. CPC H04L 12/1414; H04M 15/64; H04W 4/24

(57) ABSTRACT

A charging method, a charging device, and a charging system, where the charging method includes receiving, by an access device, information about a granted traffic volume that is returned by a charging device according to a traffic volume request, and sending, by the access device, a charging request to the charging device according to usage of the granted traffic volume by an end user, where linear traffic information carried in the charging request is a parameter related to each phase of linear traffic generated in a process in which the end user uses the granted traffic volume. Thus, information about each phase of linear traffic generated within a time in which a granted traffic volume is used is reported such that a charging device can accurately trace traffic usage at a specific time point by a user according to the linear traffic information.

### CROSS-REFERENCE TO RELATED APPLICATIONS

This application is a continuation of International Patent Application No. PCT/CN2015/080679 filed on Jun. 3, 2015, which claims priority to Chinese Patent Application No. 201410654552.4 filed on Nov. 17, 2014. The disclosures of the aforementioned applications are hereby incorporated by reference in their entireties.

### TECHNICAL FIELD

The present disclosure relates to charging technologies, and in particular, to a charging method, a charging device, and a charging system.

### BACKGROUND

Online charging is defined by the third Generation Partnership Project (3GPP). Generally, a gateway general packet radio service support node (GGSN) implements service monitoring and requesting. The GGSN interacts with an online charging system (OCS) using a Diameter Credit-Control (DCC) message using a Gy interface to complete charging for data services. Participation in charging for real-time services is emphasized when 3GPP started to define OCS online charging. In a process of performing a service, a tariff time change (TTC) is delivered using a credit control answer (CCA) message for accurate charging for traffic. The following describes a real-time charging technology with reference to FIG. 1.

FIG. 1 is an exemplary signaling diagram of a real-time charging method. In a scenario shown in FIG. 1, 8:00 is a tariff time change point, that is, a tariff time change occurs at 8:00.

Step 102: An end user sends a login request to a GGSN.

Step 104: The GGSN sends an initial credit control request (CCR{Initial}) to request to establish a bearer service and request an OCS to grant a traffic volume, where the request carries the traffic volume requested to be granted.

Step 106: The OCS performs authentication and reservation.

The OCS checks permission of the end user to determine whether the end user is permitted to use the foregoing bearer service requested to be established. The OCS establishes the bearer service for the end user, and reserves a granted traffic volume according to an account balance status of the end user if the end user has the permission.

Step 108: The OCS sends an initial credit control answer (CCA{Initial}) to the GGSN, where a granted traffic volume is carried.

Step 110: The GGSN provides a service for the end user for use after receiving the traffic volume granted by the OCS.

Step 112: When the user uses up or is about to use up the foregoing granted traffic volume, the GGSN sends an update CCR (CCR{Update}) to the OCS to request the OCS to grant a next traffic volume, where the CCR{Update} also carries a traffic volume that has been used by the user.

Step 114: The OCS deducts fees according to the traffic volume that has been used by the user, and reserves a next granted traffic volume.

Step 116: The OCS detects that a tariff time change is about to occur, and sends to the GGSN an update CCA (CCA{Update}) that carries not only the granted traffic volume but also a tariff time change.

Step 118: The GGSN sends a CCR{Update} to the OCS to request the OCS to grant a next traffic volume when the user uses up or is about to use up the granted traffic volume, and because a tariff time change has occurred, the GGSN divides the used traffic volume into two parts in the CCR{Update} according to the tariff time change point and reports traffic volumes used before and after the tariff time change.

Step 120: The OCS deducts fees according to the traffic volumes used before and after the tariff time change, and reserves a next granted traffic volume such that the user continue to use the service. Subsequent steps are not described herein.

During charging, the OCS deducts fees according to a used traffic volume reported in the CCR. In step 118, because the GGSN reports the traffic volumes used before and after the tariff time change, the OCS can perform accurate charging according to the traffic volumes used before and after the tariff time change, with no charging error resulting from the tariff time change.

However, sometimes when a charging error for a user is caused by a tariff processing error occurs, and fees need to be deducted according to actual service usage of the user, that is, re-rating, to achieve the objective of accurate charging. However, the 3GPP has never supported re-rating. Re-rating processing is not mentioned in the entire 3 GPP specification, and generally communications equipment vendors do not provide re-rating support either. In a common practice, before a tariff goes online, tariff simulation or strict tests are used to ensure accuracy of the tariff after the tariff goes online and avoid re-rating as much as possible. In fact, however, as OCSs are used more widely, in many billing support system (BSS) offices, the OCS is already a uniform support system for pre-paid and post-paid users on the entire network. For a post-paid system born of the Tele Management Forum (TMF), re-rating is a necessary charging system requirement. Because the 3GPP does not define re-rating services and supports only real-time charging over the Gy interface, re-rating can be based on only real-time traffic volumes reported during a service process, that is, for example, the used traffic volumes in FIG. 1. A situation of inaccurate re-rating may occur when a designed re-rating time point changes. For example, in FIG. 1, a tariff time change takes place at 8:00. During normal real-time charging, because the GGSN reports a traffic volume used before 8:00 and a traffic volume used after 8:00, the OCS can implement accurate charging. In some scenarios, however, if a customer requires re-rating because of an incorrect package configuration, a problem may occur. For example, a tariff time change point for a package reconfigured for the customer is 9:00, but the OCS system is unable to obtain a traffic volume used before 9:00 and a traffic volume used after 9:00 from historical records. Consequently, re-rating cannot be implemented.

### SUMMARY

Embodiments of the present disclosure provide a charging method, where information about each phase of linear traffic generated during a process of using a granted traffic volume is reported such that a charging device can perform accurate charging according to the linear traffic information.

According to a first aspect, a charging method is provided, where the method is used in a scenario in which traffic is generated because an end user initiates content access, and the method includes sending, by an access device, a traffic volume request to a charging device, receiving, by the access device, information about a granted traffic volume that is returned by the charging device according to the traffic volume request, and sending, by the access device, a charging request to the charging device according to usage of the granted traffic volume by the end user, where the charging request carries a parameter indicating linear traffic information such that the charging device performs charging according to the linear traffic information, where the linear traffic information is a parameter related to each phase of linear traffic generated during a process in which the end user uses the granted traffic volume.

With reference to an implementation manner of the first aspect, in a first possible implementation manner of the first aspect, the linear traffic information includes a volume of each phase of linear traffic, a time point when each phase of linear traffic starts to be generated, and a duration of each phase of linear traffic.

With reference to the first aspect or the first possible implementation manner of the first aspect, in a second possible implementation manner, the linear traffic information includes a bit rate of each phase of linear traffic, a time point when each phase of linear traffic starts to be generated, and a duration of each phase of linear traffic.

With reference to the first aspect or the first and the second possible implementation manners of the first aspect, in a third possible implementation manner, a manner for obtaining the linear traffic volume includes setting a timer, configuring a timing duration, and acquiring, by the access device, a used traffic volume when a traffic use duration reaches the timing duration.

With reference to the first aspect or the first to the third possible implementation manners of the first aspect, in a fourth possible implementation manner, a manner for obtaining the linear traffic bit rate includes setting a timer, configuring a timing duration, and acquiring, by the access device, a used traffic volume and determining the linear traffic bit rate according to the used traffic volume and the timing duration when a traffic use duration reaches the timing duration.

With reference to the first aspect or any one of the first to the fourth possible implementation manners of the first aspect, in a fifth possible implementation manner, the traffic volume request and the charging request are CCR messages, the information about the granted traffic volume is carried in a CCA message, and the parameter indicating linear traffic information is carried in an extension field or a reserved field in a CCR message.

With reference to the first aspect or any one of the first to the fifth possible implementation manners of the first aspect, in a sixth possible implementation manner, the linear traffic volume includes an uplink traffic volume and a downlink traffic volume, and the linear traffic bit rate includes an uplink traffic bit rate and a downlink traffic bit rate.

According to a second aspect, a charging method is provided, where the method is used in a scenario in which traffic is generated because an end user initiates content access, and the method includes the following steps receiving, by a charging device, a traffic volume request sent by an access device, returning, by the charging device, information about a granted traffic volume to the access device according to the traffic volume request, receiving, by the charging device, a charging request sent by the access device, where the charging request carries a parameter indicating linear traffic information, where the linear traffic information is a parameter related to each phase of linear traffic generated during a process in which the end user uses the granted traffic volume, and performing, by the charging device, charging according to the linear traffic information.

With reference to an implementation manner of the second aspect, in a first possible implementation manner of the second aspect, the linear traffic information includes a volume of each phase of linear traffic, a time point when each phase of linear traffic starts to be generated, and a duration of each phase of linear traffic.

With reference to the second aspect or the first possible implementation manner of the second aspect, in a second possible implementation manner, the linear traffic information includes a bit rate of each phase of linear traffic, a time point when each phase of linear traffic starts to be generated, and a duration of each phase of linear traffic.

With reference to the second aspect or the first and the second possible implementation manners of the second aspect, in a third possible implementation manner, performing charging according to the linear traffic information includes re-rating traffic.

With reference to the second aspect or the first to the third possible implementation manners of the second aspect, in a fourth possible implementation manner, the charging request is a CCR, and the parameter indicating linear traffic information is carried in an extension field or a reserved field in the credit control request.

With reference to the second aspect or any one of the first to the fourth possible implementation manners of the second aspect, in a fifth possible implementation manner, the linear traffic volume includes an uplink traffic volume and a downlink traffic volume, and the linear traffic bit rate includes an uplink traffic bit rate and a downlink traffic bit rate.

According to a third aspect, an access device is provided, where the access device is used in a scenario in which traffic is generated because an end user initiates content access, and includes a sending module and a receiving module, where the sending module is configured to send a traffic volume request to a charging device. The receiving module is configured to receive information about a granted traffic volume that is returned by the charging device according to the traffic volume request, and the sending module is further configured to send a charging request to the charging device according to usage of the granted traffic volume by the end user, where the charging request carries a parameter indicating linear traffic information such that the charging device performs charging according to the linear traffic information, where the linear traffic information is a parameter related to each phase of linear traffic generated during a process in which the end user uses the granted traffic volume.

With reference to an implementation manner of the third aspect, in a first possible implementation manner of the third aspect, the linear traffic information includes a volume of each phase of linear traffic, a time point when each phase of linear traffic starts to be generated, and a duration of each phase of linear traffic.

With reference to the third aspect or the first possible implementation manner of the third aspect, in a second possible implementation manner, the linear traffic information includes a bit rate of each phase of linear traffic, a time point when each phase of linear traffic starts to be generated, and a duration of each phase of linear traffic.

With reference to the third aspect or the first and the second possible implementation manners of the third aspect, in a third possible implementation manner, a manner for obtaining the linear traffic volume includes setting a timer, configuring a timing duration, and acquiring, by the access device, a used traffic volume when a traffic use duration reaches the timing duration.

With reference to the third aspect or the first to the third possible implementation manners of the third aspect, in a fourth possible implementation manner, a manner for obtaining the linear traffic bit rate includes setting a timer, configuring a timing duration, and acquiring, by the access device, a used traffic volume and determining the linear traffic bit rate according to the used traffic volume and the timing duration when a traffic use duration reaches the timing duration.

With reference to the third aspect or any one of the first to the fourth possible implementation manners of the third aspect, in a fifth possible implementation manner, the traffic volume request and the charging request are CCR messages, the information about the granted traffic volume is carried in a CCA message, and the parameter indicating linear traffic information is carried in an extension field or a reserved field in a CCR message.

With reference to the third aspect or the first to the fifth possible implementation manners of the third aspect, in a sixth possible implementation manner, the linear traffic volume includes an uplink traffic volume and a downlink traffic volume, and the linear traffic bit rate includes an uplink traffic bit rate and a downlink traffic bit rate.

According to a fourth aspect, a charging device is provided, where the charging device is used in a scenario in which traffic is generated because an end user initiates content access, and includes a receiving module, a sending module, and a charging module, where the receiving module is configured to receive a traffic volume request sent by an access device. The sending module is configured to return information about a granted traffic volume to the access device according to the traffic volume request. The receiving module is further configured to receive a charging request sent by the access device, where the charging request carries a parameter indicating linear traffic information, where the linear traffic information is a parameter related to each phase of linear traffic generated during a process in which the end user uses the granted traffic volume, and the charging module is configured to perform charging according to the linear traffic information.

With reference to an implementation manner of the fourth aspect, in a first possible implementation manner of the fourth aspect, the linear traffic information includes a volume of each phase of linear traffic, a time point when each phase of linear traffic starts to be generated, and a duration of each phase of linear traffic.

With reference to the fourth aspect or the first possible implementation manner of the fourth aspect, in a second possible implementation manner, the linear traffic information includes a bit rate of each phase of linear traffic, a time point when each phase of linear traffic starts to be generated, and a duration of each phase of linear traffic.

With reference to the fourth aspect or the first and the second possible implementation manners of the fourth aspect, in a third possible implementation manner, performing charging according to the linear traffic information includes re-rating traffic.

With reference to the fourth aspect or the first to the third possible implementation manners of the fourth aspect, in a fourth possible implementation manner, the charging request is a CCR, and the parameter indicating linear traffic information is carried in an extension field or a reserved field in the CCR message.

With reference to the fourth aspect or any one of the first to the fourth possible implementation manners of the fourth aspect, in a fifth possible implementation manner, the linear traffic volume includes an uplink traffic volume and a downlink traffic volume, and the linear traffic bit rate includes an uplink traffic bit rate and a downlink traffic bit rate.

According to a fifth aspect, a charging system is provided, including an access device and a charging device, where the access device is configured to send a traffic volume request to the charging device, receive information about a granted traffic volume that is returned by the charging device according to the traffic volume request, and send a charging request to the charging device according to usage of the granted traffic volume by the end user, where the charging request carries a parameter indicating linear traffic information such that the charging device performs charging according to the linear traffic information, where the linear traffic information is a parameter related to each phase of linear traffic generated in a process in which the end user uses the granted traffic volume, and the charging device is configured to receive the traffic volume request sent by the access device, return the information about the granted traffic volume to the access device according to the traffic volume request, receive the charging request sent by the access device, where the charging request carries the parameter indicating linear traffic information, and perform charging according to the linear traffic information.

According to a sixth aspect, a computing device is provided, including a processor, a memory, a bus, and a communications interface, where the memory is configured to store a computing device executable instruction, and the processor is connected to the memory using the bus, and the processor executes the computing device executable instruction stored in the memory when the computing device is running such that the computing device executes the method according to the first aspect or the second aspect or any possible implementation manner of the first aspect or the second aspect.

According to the technical solutions provided in the embodiments of the present disclosure, information about each phase of linear traffic generated within a time in which a granted traffic volume is used is reported such that a charging device obtains detailed traffic usage, and can accurately trace traffic usage at a specific time point by a user according to the linear traffic information, thereby enabling accurate charging.

### BRIEF DESCRIPTION OF DRAWINGS

FIG. 1 is an exemplary signaling diagram of a real-time charging method;

FIG. 2 is a schematic diagram of a network architecture applied to an embodiment of the present disclosure;

FIG. 3 is an exemplary flowchart of a charging method according to an embodiment of the present disclosure;

FIG. 4 is an exemplary flowchart of a charging method according to an embodiment of the present disclosure;

FIG. 5 is an exemplary signaling diagram of a charging method according to an embodiment of the present disclosure;

FIG. 6 is a schematic diagram of linear traffic information according to an embodiment of the present disclosure;

FIG. 7 is a schematic structural diagram of an access device according to an embodiment of the present disclosure;

FIG. 8 is a schematic structural diagram of a charging device according to an embodiment of the present disclosure;

FIG. 9 is a schematic structural diagram of a charging system according to an embodiment of the present disclosure; and

FIG. 10 is a schematic diagram of a hardware structure of a general-purpose computer structure according to an embodiment of the present disclosure.

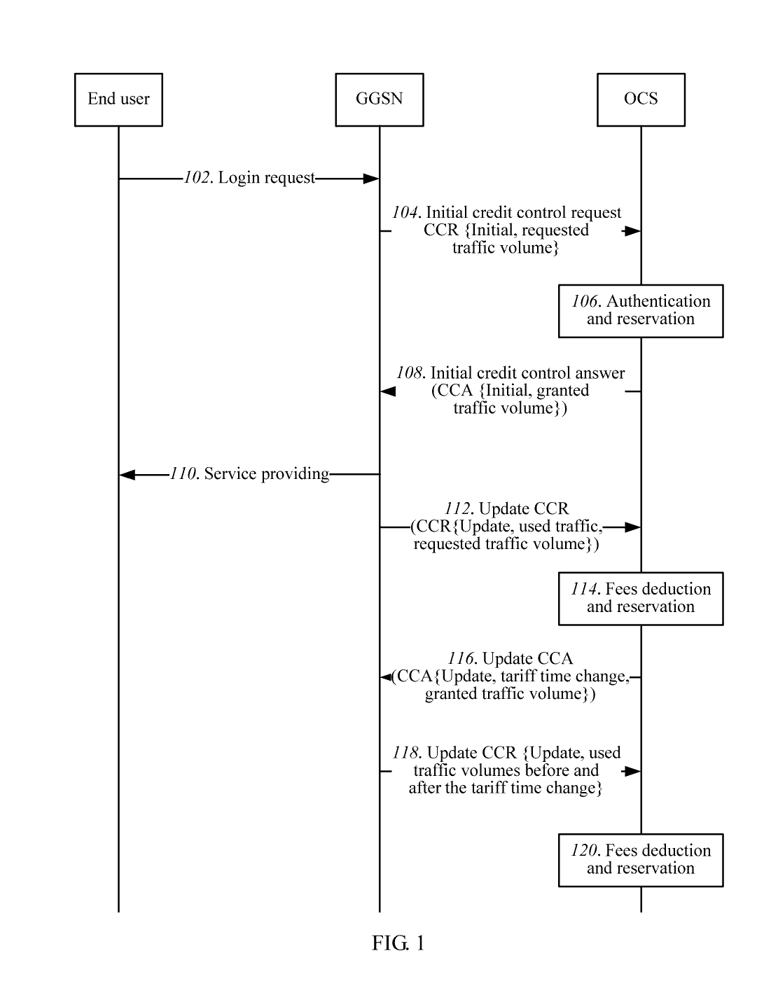

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments are a part rather than all of the embodiments of the present disclosure. All other embodiments obtained by persons of ordinary skill in the art based on the embodiments of the present disclosure without creative efforts shall fall within the protection scope of the present disclosure.

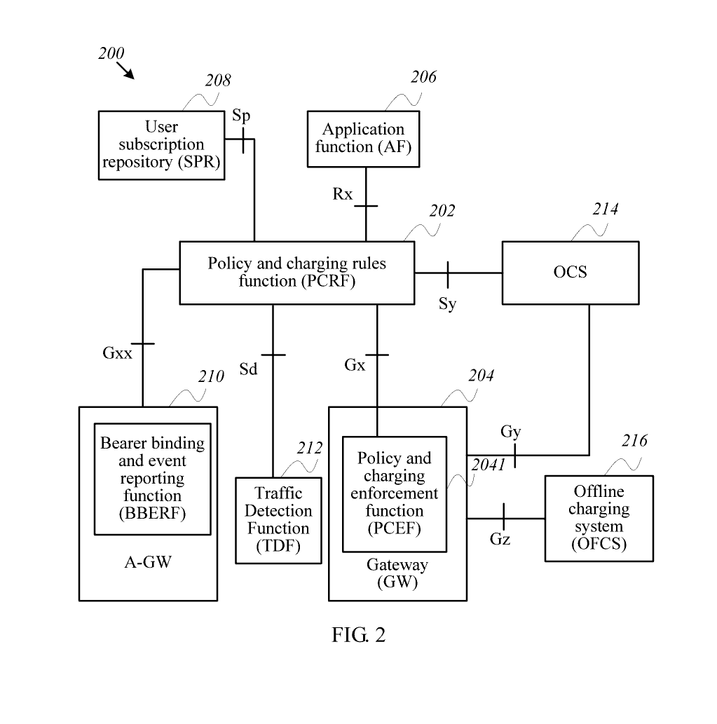

FIG. 2 is a schematic diagram of a network architecture applied to an embodiment of the present disclosure. The network architecture 200 includes a policy and charging rules function (PCRF) 202, a policy and charging enforcement function (PCEF) 2041, an application function (AF) 206, a subscription profile repository (SPR) 208, a bearer binding and event reporting function (BBERF) 210, a Traffic Detection Function (TDF) 212, an OCS 214, and an offline charging system (OFCS) 216.

The PCRF 202 includes policy control decision and traffic-based charging control functions. The PCRF 202 receives input from the PCEF 2041 using a Gx interface to provide the PCEF 2041 with network control functions regarding service data flow detection, gating control, quality of service (QoS) control, and traffic-based charging. The PCRF 202 sends policy and charging rules formulated by the PCRF 202 to the PCEF 2041 for execution, and the PCRF 202 also needs to ensure that these rules are consistent with user subscription information. A basis for the PCRF 202 to formulate the policy and charging rules includes service related information acquired from the AF 206 using interface Rx, user policy charging control subscription information acquired from the SPR 208 using interface Sp, and bearer-related network information acquired from the PCEF 2041.

The PCEF 2041 mainly includes functions, including service data flow detection, policy enforcement, and traffic-based charging. The PCEF 2041 function is usually located in a gateway (GW) 204, such as a GGSN gateway, a packet data network gateway (P-GW) in a fourth generation (4G) evolved packet core (EPC), or a packet data gateway (PDG) in a wireless local area network (WLAN). The PCEF 2041 may also be deployed independently.

Functions of the BBERF 210 include bearer binding, uplink bear binding verification, and event reporting. This function is located in a gateway, such as a service gateway (S-GW) that uses Proxy Mobile Internet Protocol (IP) (PMIP) based on an S5/S8 interface to implement 3GPP access, a high rate packet data (HRPD) service gateway in HRPD, or an access gateway (A-GW) in a non-3G access scenario. The BBERF 210 is connected to the PCRF 202 using a Gxx interface.

The TDF 212 executes application program detection and report detection. For example, the TDF 212 can recognize deep packet inspection (DPI). The TDF 212 executes gating control to redirect bandwidth restriction if the TDF 212 does not detect the information. The TDF 212 is connected to the PCRF 202 using an Sd interface. If application program information can be detected, the information is submitted to the PCRF 202, and then the PCRF 202 generates a decision and submits the decision to the PCEF 2041 for control.

The OCS 214 provides user- and service data flow-based credit control functions. The OCS 214 mainly includes modules of online collection, charging control, rating, balance management, and the like, implementing an online charging function, and cooperates with another charging network element device (a session- or event-based online charging event requesting device, such as a service control point (SCP), a content charging gateway (CCG), or an integrated business management platform (ISMP)) to perform real-time traffic control. The OCS 214 is connected to the PCEF 2041 using a Gy interface. The OCS 214 is connected to the PCRF 202 using an Sy interface.

The OFCS 216 and the PCEF 2041 together complete a charging operation in an offline charging manner using interface Gz.

In the embodiments of the present disclosure, it is considered that the PCEF is located in the GGSN gateway.

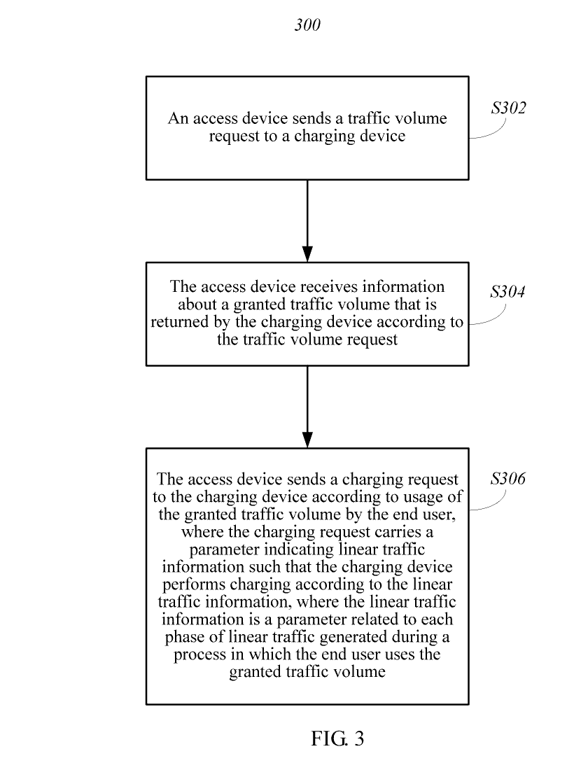

FIG. 3 is an exemplary flowchart of a charging method according to an embodiment of the present disclosure. In a specific implementation process, the charging method 300 may be executed by, for example, an access device, but is not limited thereto, where the access device may be, for example, a GGSN, but is not limited thereto. In this embodiment, a charging device communicates with the access device according to the Diameter protocol.

Step S302: An access device sends a traffic volume request to a charging device.

Optionally, the traffic volume request may be a CCR message.

Step S304: The access device receives information about a granted traffic volume that is returned by the charging device according to the traffic volume request, where “the information about the granted traffic volume that is returned by the charging device according to the traffic volume request” is a message that carries a parameter indicating the information about the granted traffic volume and that is returned by the charging device according to the traffic volume request.

Optionally, the message that carries the information about the granted traffic volume may be a CCA message. Further, the message that carries the parameter indicating the information about the granted traffic volume may be a CCA message.

Step S306: The access device sends a charging request to the charging device according to usage of the granted traffic volume by the end user, where the charging request carries a parameter indicating linear traffic information such that the charging device performs charging according to the linear traffic information, where the linear traffic information is a parameter related to each phase of linear traffic generated during a process in which the end user uses the granted traffic volume.

Optionally, the linear traffic information includes a volume of each phase of linear traffic, a time point when each phase of linear traffic starts to be generated, and a duration of each phase of linear traffic, where the volume of each phase of linear traffic refers to a linear traffic volume of each phase of linear traffic.

Optionally, the linear traffic information includes a bit rate of each phase of linear traffic, a time point when each phase of linear traffic starts to be generated, and a duration of each phase of linear traffic, where the bit rate of each phase of linear traffic refers to a traffic bit rate of each phase of linear traffic.

Optionally, a manner for obtaining the linear traffic volume includes setting a timer, configuring a timing duration, and acquiring, by the access device, a used traffic volume when a traffic use duration reaches the timing duration.

Optionally, a manner for obtaining the linear traffic bit rate includes setting a timer, configuring a timing duration, and acquiring, by the access device, a used traffic volume and determining the linear traffic bit rate according to the used traffic volume and the timing duration when a traffic use duration reaches the timing duration, where the linear traffic bit rate refers to a traffic bit rate of the foregoing linear traffic.

Optionally, the charging request is a CCR message, and the parameter indicating linear traffic information is carried in an extension field or a reserved field in the CCR message, and further, the parameter indicating the linear traffic information is carried in an extension field in the CCR message or carried in a reserved field in the CCR message.

According to the technical solution provided in this embodiment of the present disclosure, information about each phase of linear traffic generated within a time in which a granted traffic volume is used is reported such that a charging device obtains detailed traffic usage, and can accurately trace traffic usage at a specific time point by a user according to the linear traffic information, thereby enabling accurate charging.

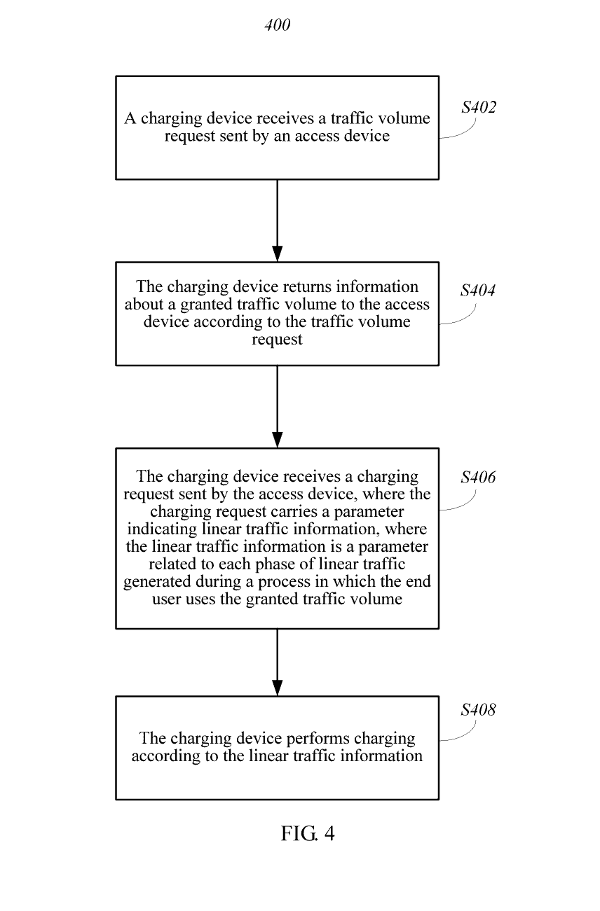

FIG. 4 is an exemplary flowchart of a charging method according to an embodiment of the present disclosure. In a specific implementation process, the charging method 400 may be executed by, for example, a charging device, but is not limited thereto. The charging device may be, for example, a pre-paid server (PPS), but is not limited thereto. Further, the PPS may be further, for example, an OCS, but is not limited thereto.

Step S402: A charging device receives a traffic volume request sent by an access device.

Step S404: The charging device returns information about a granted traffic volume to the access device according to the traffic volume request. That the charging device returns information about a granted traffic volume to the access device according to the traffic volume request includes that the charging device returns, to the access device according to the traffic volume request, a message that carries a parameter indicating the information about the granted traffic volume.

Step S406: The charging device receives a charging request sent by the access device, where the charging request carries a parameter indicating linear traffic information, where the linear traffic information is a parameter related to each phase of linear traffic generated during a process in which the end user uses the granted traffic volume.

Optionally, the linear traffic information includes a volume of each phase of linear traffic, a time point when each phase of linear traffic starts to be generated, and a duration of each phase of linear traffic, where the volume of each phase of linear traffic refers to a linear traffic volume of each phase of linear traffic.

Optionally, the linear traffic information includes a bit rate of each phase of linear traffic, a time point when each phase of linear traffic starts to be generated, and a duration of each phase of linear traffic, where the bit rate of each phase of linear traffic refers to a traffic bit rate of each phase of linear traffic.

Step S408: The charging device performs charging according to the linear traffic information.

Optionally, the performing charging according to the linear traffic information includes re-rating traffic.

According to the technical solution provided in this embodiment of the present disclosure, information about each phase of linear traffic generated within a time in which a granted traffic volume is used is reported such that a charging device obtains detailed traffic usage, and can accurately trace traffic usage at a specific time point by a user according to the linear traffic information, thereby enabling accurate charging.

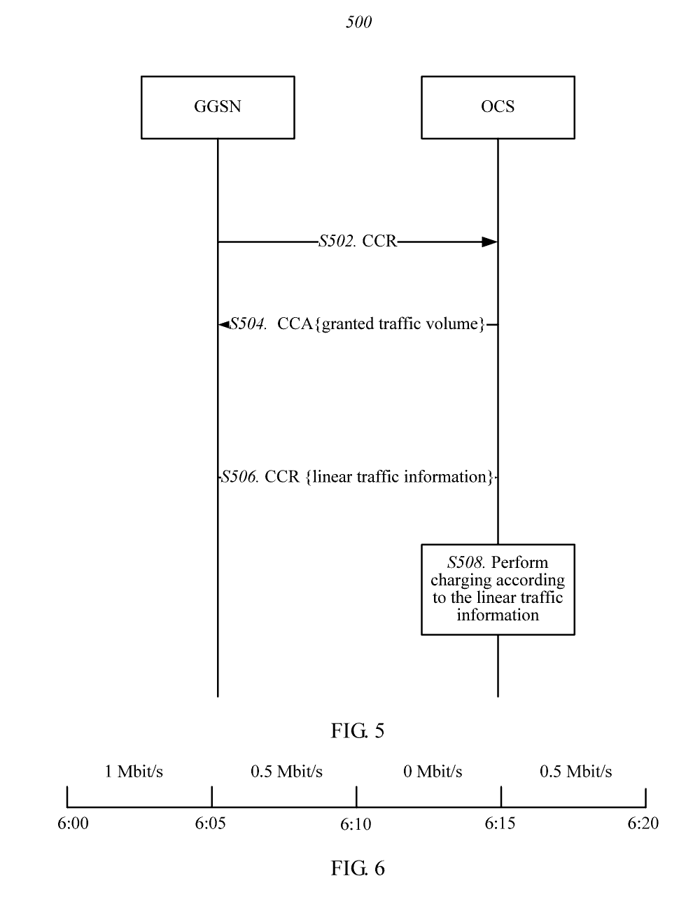

FIG. 5 is an exemplary signaling diagram of a charging method according to an embodiment of the present disclosure. In a specific implementation process, the charging method 500 may be executed by, for example, an access device and a charging device, but is not limited thereto. In this embodiment, the access device may be, for example, a GGSN, but is not limited thereto. The charging device may be, for example, a PPS, but is not limited thereto. Further, a PPS may be further, for example, an OCS, but is not limited thereto. The access device communicates with the charging device according to the Diameter protocol. In FIG. 5, the GGSN sends a CCR message to request the OCS to grant a traffic volume. The OCS sends a granted traffic volume to the GGSN according to the CCR message using the CCA message, and after receiving the traffic volume granted by the OCS, the GGSN provides a service for an end user such that the end user uses the granted traffic volume. Linear traffic information is generated when the end user uses the granted traffic volume. The GGSN reports the linear traffic information to the OCS using a CCR message, and the OCS performs charging according to the linear traffic information.

Step S502: A GGSN sends a CCR message to an OCS, where the CCR message is a traffic volume request used to request the OCS to grant a traffic volume.

Step S504: The OCS sends a CCA message to the GGSN, where information about a granted traffic volume is carried.

The OCS grants, according to an account balance status of the end user, the traffic volume requested by the GGSN. Further, when an account balance of the end user is sufficient to pay for the traffic volume requested by the GGSN, granting is performed in the following two manners.

In a first manner, the OCS grants the traffic volume requested by the GGSN.

In a second manner, the OCS determines a granted traffic volume according to an internal policy, and may usually dynamically adjust the granted traffic volume according to a network used by the user, a network speed, or a status of a service package purchased by the user. In this case, the granted traffic volume may not necessarily be the same as the traffic volume requested by the GGSN.

If the account balance of the end user is not sufficient to pay for the traffic volume requested by the GGSN, a traffic volume for which the account balance can be paid is granted.

Step S506: Generate linear traffic information during a process in which an end user uses the granted traffic volume, and the GGSN sends the linear traffic information to the OCS using a CCR message.

Step S508: The OCS performs charging according to the linear traffic information.

Further, the OCS may accurately trace traffic usage according to the linear traffic information, to re-rate traffic.

In step S506, because the traffic bit rate is not necessarily constant during a process of using a service, for example, surfing the Internet, by the end user, a situation in which traffic rates are different in different time periods may occur during the process of using the granted traffic volume. For example, in a case shown in FIG. 6, in FIG. 6, the OCS grants the GGSN 600 megabits (Mbit) of traffic, during a process in which the end user surfs the Internet using the 600 Mbit of traffic, in a time period from 6:00 to 6:05, a traffic bit rate is 1 Mbit/second (s), in a time period from 6:05 to 6:10, a traffic bit rate is 0.5 Mbit/s, in a time period from 6:10 to 6:15, a traffic bit rate is 0 Mbit/s, and in a time period from 6:15 to 6:20, a traffic bit rate is 0.5 Mbit/s.

A continuous time with a same traffic bit rate is a linear traffic phase. For example, in FIG. 6, the time period from 6:00 to 6:05 with the traffic bit rate 1 Mbit/s is a linear traffic phase. A total volume of traffic in a linear traffic phase is referred to as a linear traffic volume. For example, in FIG. 6, a total volume of traffic in the time period from 6:00 to 6:05 is 1 Mbit/s×60 s×5=300 Mbit, and 300 Mbit is a linear traffic volume in this linear traffic phase. The continuous time is referred to as Phase-Duration, a duration of the phase of linear traffic. For example, for the linear traffic phase from 6:00 to 6:05 shown in FIG. 6, five minutes is a duration of the phase of linear traffic. A start time point of the duration is referred to as Start-Time, a time point when the phase of linear traffic starts to be generated. For example, for the linear traffic phase from 6:00 to 6:05 in FIG. 6, 6:00 is a time point when the phase of linear traffic starts to be generated.

The GGSN sends linear traffic information of each linear traffic phase to the OCS, where the linear traffic information of each linear traffic phase includes but is not limited to either of the following two cases.

In a first case, a linear traffic volume, a Start-Time that is a time point when the phase of linear traffic starts to be generated, and a Phase-Duration that is a duration of the phase of linear traffic are included, where the linear traffic volume includes an uplink traffic volume Output-Quota and a downlink traffic volume Input-Quota. The GGSN may upload a sum of the uplink traffic volume Output-Quota and the downlink traffic volume Input-Quota, or may upload the uplink traffic volume Output-Quota and the downlink traffic volume Input-Quota as two pieces of data. That “the GGSN may upload a sum of the uplink traffic volume Output-Quota and the downlink traffic volume Input-Quota, or may upload the uplink traffic volume Output-Quota and the downlink traffic volume Input-Quota as two pieces of data” may be that the GGSN may upload a sum of traffic volumes of the uplink traffic volume and the downlink traffic volume, or may upload the uplink traffic volume and the downlink traffic volume as two pieces of data.

In a second case, a linear traffic bit rate, a Start-Time that is a time point when the phase of linear traffic starts to be generated, and a Phase-Duration that is a duration of the phase of linear traffic are included, where the linear traffic bit rate includes an uplink traffic bit rate Output-Quota-Ratio and a downlink traffic bit rate Input-Quota-Ratio. The GGSN may upload a sum of rates of the uplink traffic bit rate Output-Quota-Ratio and the downlink traffic bit rate Input-Quota-Ratio, or may upload the uplink traffic bit rate Output-Quota-Ratio and the downlink traffic bit rate Input-Quota-Ratio as two pieces of data, where the linear traffic bit rate refers to a traffic bit rate of the linear traffic phase.

In a specific implementation process, the linear traffic volume or the linear traffic bit rate may be determined by setting a timer, configuring a timing duration, and acquiring a used traffic volume when a traffic use duration reaches the timing duration.

Further, when the GGSN sends the linear traffic information in the foregoing first case, that is, sends a volume of each phase of linear traffic, a Start-Time that is a time point when each phase of linear traffic starts to be generated, and a Phase-Duration that is a duration of each phase of linear traffic to the OCS, the timing duration may be set to one second, and the GGSN acquires a used traffic volume when a traffic use duration reaches one second. In this way, the Phase-Duration that is the duration of each phase of linear traffic is the same, and the Phase-Duration is equal to one second. In the process in which the user uses the OCS-granted traffic volume, the GGSN acquires, at each one second, a volume of traffic used within the one second, and sends the used traffic volume, a time point when the used traffic starts to be generated, and the duration one second to the OCS. As described above, the used traffic volume includes an uplink traffic volume and a downlink traffic volume. The GGSN may upload a sum of the uplink traffic volume and the downlink traffic volume, that is, the used traffic volume within the one second, or may upload the uplink traffic volume and the downlink traffic volume as two pieces of data. In specific implementation, the timing duration may be determined by an operator. For different timing durations, an error may exist between the traffic volume acquired by the GGSN and a traffic volume actually used by the user within the timing duration, and the operator may set a length of a timing duration according to an error range that is acceptable by the operator. Setting the timing duration to one second in the present disclosure is merely to provide a feasible manner, and is not intended to limit the protection scope of the present disclosure. The foregoing “for different timing durations, an error may exist between the traffic volume acquired by the GGSN and a traffic volume actually used by the user within the timing duration” may be because the Phase-Duration is different when the timing duration is different, when the timing duration is long, for example, five minutes, a traffic bit rate within a Phase-Duration may not be constant, and therefore, an error may exist between the timing duration used as a duration of a linear traffic phase and an actual duration of the linear traffic phase.

Optionally, if traffic volumes used within multiple continuous timing durations are the same, the multiple continuous timing durations may be combined as one Phase-Duration, a duration of one linear traffic phase, and the duration Phase-Duration after combination, a total traffic volume generated within the Phase-Duration after combination, and a Start-Time that is a time point when a first timing duration of the multiple timing durations starts are reported to the OCS. For example, the timing duration is one second, and the GGSN acquires a used traffic volume once a second. If in a time of 10 continuous one seconds, a used traffic volume in each one second is 1 Mbit, and a used traffic volume in the 11^{th} one second is not 1 Mbit, the 10 one seconds may be combined as 10 seconds. In this case, the 10 seconds is a duration Phase-Duration of one linear traffic phase, and a total volume of linear traffic within the linear traffic phase is 10 Mbit. If a time point when the first one second of the 10 one seconds starts is 6:00, a Start-Time of the linear traffic phase is 6:00. The GGSN sends information indicating 10 seconds, 10 Mbit, and 6:00 to the OCS using a CCR message. Because the Start-Time of the first timing duration is the same as the Start-Time of the linear traffic phase obtained by combining multiple timing durations, reporting the Start-Time of the first timing duration is equal to reporting the Start-Time of the linear traffic phase after combination.

When the GGSN sends the linear traffic information of the second case, that is, sends a linear traffic bit rate, a Start-Time that is a time point when each phase of linear traffic starts to be generated, and a Phase-Duration that is a duration of each phase of linear traffic, to the OCS, the timing duration is set to one second and the GGSN acquires used traffic each one second. The used traffic acquired by the GGSN is the linear traffic bit rate. If rates in several continuous seconds are the same, for example, rates in several continuous seconds are all 1 Mbit/s, the several seconds may be combined as a Phase-Duration that is a duration of one linear traffic phase, and the duration Phase-Duration after combination, the traffic bit rate in the duration, and a Start-Time that is a time point when the duration starts are reported to the OCS. For example, the timing duration is set to one second, and the GGSN acquires used traffic each one second to obtain a traffic bit rate. If a traffic bit rate in a time of 10 continuous seconds is always 1 Mbit/s, and a traffic bit rate in the 11^{th} second is not 1 Mbit/s, the first 10 seconds may be combined. In this case, the 10 seconds are a Phase-Duration that is a duration of one linear traffic phase and a linear traffic bit rate in the linear traffic phase is 1 Mbit/s. If a time point when the 10 seconds starts is 6:00, a Start-Time of the linear traffic phase is 6:00. The GGSN sends information indicating 10 seconds, 1 Mbit/s, and 6:00 to the OCS using a CCR message.

Optionally, a traffic bit rate in each second may also be reported to the GGSN. In this case, the Phase-Duration may not be reported, and the reported linear traffic information is the linear traffic bit rate and the Start-Time that the time point when each phase of linear traffic starts to be generated.

When the foregoing linear traffic information is reported, a linear traffic phase without traffic generated may not be reported, for example, the time period from 6:10 to 6:15 in FIG. 6, and only a linear traffic phase with traffic generated is reported, for example, the time periods from 6:00 to 6:05, from 6:05 to 6:10, and from 6:15 to 6:20. “Without traffic generated” means that no traffic is consumed, and “with traffic generated” means that traffic is consumed.

When the linear traffic information is reported to the OCS, parameters indicating the linear traffic volume, the linear traffic bit rate, the time point when each phase of linear traffic starts to be generated, and the duration of each phase of linear traffic may be carried in extension fields in the CCR message or may be carried in reserved fields in the CCR message. For example, the following fields are extended in the CCR message to report the linear traffic volume, the time point when each phase of linear traffic starts to be generated, and the duration of each phase of linear traffic:

```
USU-Quota-Information:: = <AVP Header:**>
                        [Start-Time]
                        [Phase-Duration]
                        [Output-Quota]
                        [Input-Quota]
                        *[AVP]
```

Optionally, the GGSN sends information about each phase of linear traffic to the OCS using a CCR message requesting a next granted traffic volume.

The foregoing steps enable the OCS to obtain detailed traffic usage, and re-rating can be implemented. For example, during normal charging, a tariff time change takes place at 5:00. However, because of an incorrect package configuration, a tariff time change point of a newly configured package is 6:08. Because the GGSN reports linear traffic information with a Start-Time being 6:05, a Phase-Duration being five minutes, and a traffic bit rate being 0.5 Mbit/s, it may be obtained by calculation that a traffic volume before the tariff time change point 6:08, that is, in a time period from 6:05 to 6:08, is 0.5 Mbit/s×60 s×3=90 Mbit, and a traffic volume after the tariff time change point 6:08, that is, in a time period from 6:08 to 6:10, is 0.5 Mbit/s×60 s×2=60 Mbit. Because the GGSN reports the bit rate of each phase of linear traffic, the time point when each phase of linear traffic starts to be generated, and the duration of each phase of linear traffic, traffic volumes before 6:05 and after 6:10 may be calculated using the same method. A traffic volume before the tariff time change point 6:08 is obtained by adding the traffic volume before 6:05 and the traffic volume in the time period from 6:05 to 6:08, and a traffic volume after the tariff time change point 6:08 is obtained by adding the traffic volume after 6:10 and the traffic volume in the time period from 6:08 to 6:10. In this way, traffic usage is traced. Then, based on tariffs before and after 6:08, fees incurred according to the traffic volumes used before and after 6:08 may be obtained, and then the traffic may be re-rated.

According to the technical solution provided in this embodiment of the present disclosure, information about each phase of linear traffic generated within a time in which a granted traffic volume is used is reported such that a charging device obtains detailed traffic usage, and can accurately trace traffic usage at a specific time point by a user according to the linear traffic information, thereby enabling accurate charging. Continuous time periods with a same used traffic volume or a same bit rate are combined, which can decrease an amount of reported data, and reduce network load.

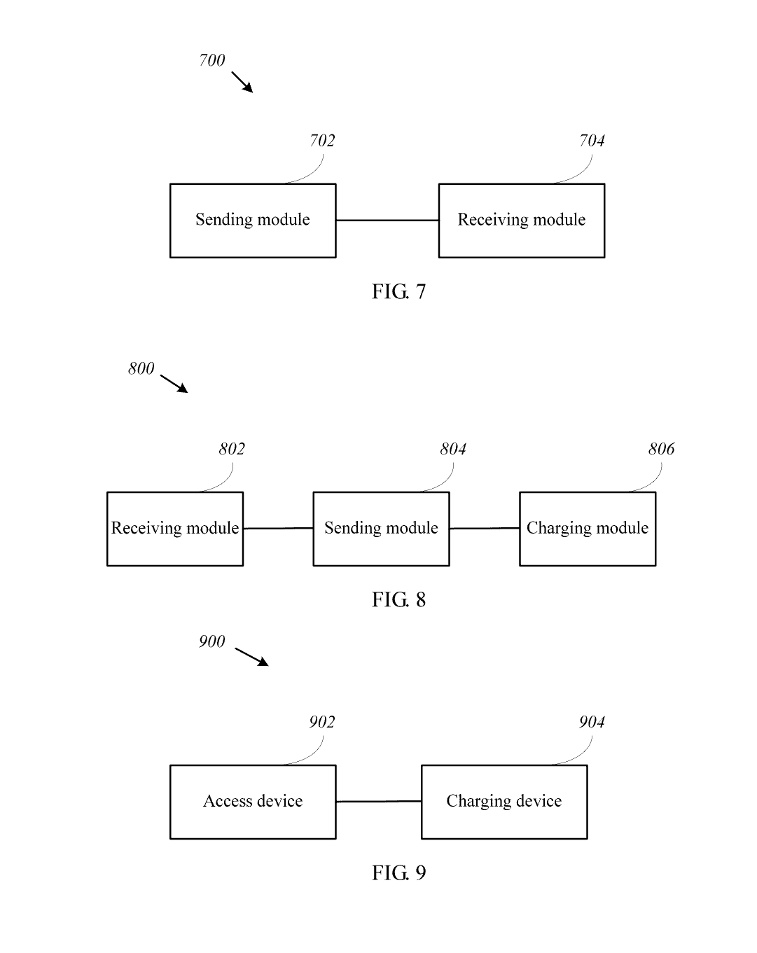

FIG. 7 is a schematic structural diagram of an access device according to an embodiment of the present disclosure. The access device is configured to perform the charging method in the foregoing embodiment in FIG. 3. The access device 700 includes a sending module 702 and a receiving module 704.

The sending module 702 is configured to send a traffic volume request to a charging device.

The receiving module 704 is configured to receive information about a granted traffic volume that is returned by the charging device according to the traffic volume request.

The sending module 702 is further configured to send a charging request to the charging device according to usage of the granted traffic volume by the end user, where the charging request carries a parameter indicating linear traffic information such that the charging device performs charging according to the linear traffic information, where the linear traffic information is a parameter related to each phase of linear traffic generated during a process in which the end user uses the granted traffic volume.

Optionally, the linear traffic information includes a volume of each phase of linear traffic, a time point when each phase of linear traffic starts to be generated, and a duration of each phase of linear traffic.

Optionally, a manner for obtaining the linear traffic volume may be setting a timer, configuring a timing duration, and acquiring, by the access device, a used traffic volume when a traffic use duration reaches the timing duration.

Optionally, the linear traffic information includes a bit rate of each phase of linear traffic, a time point when each phase of linear traffic starts to be generated, and a duration of each phase of linear traffic.

Optionally, a manner for obtaining the linear traffic bit rate may be setting a timer, configuring a timing duration, acquiring, by the access device, a used traffic volume and determining the linear traffic bit rate according to the used traffic volume and the timing duration when a traffic use duration reaches the timing duration.

According to the technical solution provided in this embodiment of the present disclosure, information about each phase of linear traffic generated within a time in which a granted traffic volume is used is reported such that a charging device obtains detailed traffic usage, and can accurately trace traffic usage at a specific time point by a user according to the linear traffic information, thereby enabling accurate charging.

FIG. 8 is a schematic structural diagram of a charging device according to an embodiment of the present disclosure. The charging device is configured to perform the charging method in the foregoing embodiment in FIG. 4. The charging device 800 includes a receiving module 802, a sending module 804, and a charging module 806.

The receiving module 802 is configured to receive a traffic volume request sent by an access device.

The sending module 804 is configured to return information about a granted traffic volume to the access device according to the traffic volume request.

The receiving module 802 is further configured to receive a charging request sent by the access device, where the charging request carries a parameter indicating linear traffic information, where the linear traffic information is a parameter related to each phase of linear traffic generated during a process in which the end user uses the granted traffic volume.

The charging module 806 is configured to perform charging according to the linear traffic information.

Optionally, the linear traffic information includes a volume of each phase of linear traffic, a time point when each phase of linear traffic starts to be generated, and a duration of each phase of linear traffic.

Optionally, the linear traffic information includes a bit rate of each phase of linear traffic, a time point when each phase of linear traffic starts to be generated, and a duration of each phase of linear traffic.

According to the technical solution provided in this embodiment of the present disclosure, information about each phase of linear traffic generated within a time in which a granted traffic volume is used is reported such that a charging device 800 obtains detailed traffic usage, and can accurately trace traffic usage at a specific time point by a user according to the linear traffic information, thereby enabling accurate charging.

FIG. 9 is a schematic structural diagram of a charging system according to an embodiment of the present disclosure. The charging system 900 includes an access device 902 and a charging device 904.

The access device 902 is configured to send a traffic volume request to the charging device 904, receive information about a granted traffic volume that is returned by the charging device 904 according to the traffic volume request, and send a charging request to the charging device 904 according to usage of the granted traffic volume by the end user, where the charging request carries a parameter indicating linear traffic information such that the charging device 904 performs charging according to the linear traffic information, where the linear traffic information is a parameter related to each phase of linear traffic generated during a process in which the end user uses the granted traffic volume.

The charging device 904 is configured to receive the traffic volume request sent by the access device 902, return the information about the granted traffic volume to the access device 902 according to the traffic volume request, receive the charging request sent by the access device 902, where the charging request carries the parameter indicating linear traffic information, and perform charging according to the linear traffic information.

The “information about the granted traffic volume that is returned by the charging device 904 according to the traffic volume request” includes a message that carries the parameter indicating the information about the granted traffic volume and that is returned by the charging device 904 according to the traffic volume request.

According to the technical solution provided in this embodiment of the present disclosure, information about each phase of linear traffic generated within a time in which a granted traffic volume is used is reported such that a charging device 904 obtains detailed traffic usage, and can accurately trace traffic usage at a specific time point by a user according to the linear traffic information, thereby enabling accurate charging.

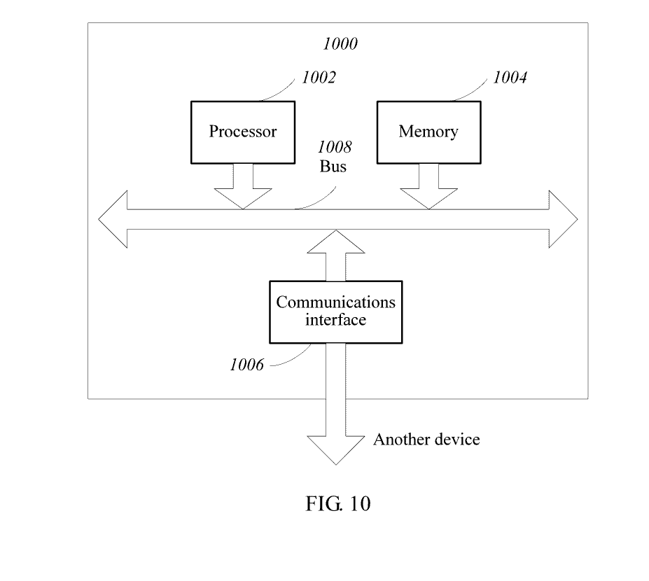

FIG. 10 is a schematic diagram of a hardware structure of a general-purpose computer structure 1000 according to an embodiment of the present disclosure. As shown in FIG. 10, the general-purpose computer structure 1000 includes a processor 1002, a memory 1004, a communications interface 1006, and a bus 1008. The processor 1002, the memory 1004, and the communications interface 1006 implement mutual communication connections using the bus 1008.

The processor 1002 may be a general-purpose central processing unit (CPU), a microprocessor, an application-specific integrated circuit (ASIC), or one or more integrated circuits, and is configured to execute a related program in order to implement the technical solutions provided in the embodiments of the present disclosure.

The memory 1004 may be a read-only memory (ROM), a static storage device, a dynamic storage device, or a random access memory (RAM). The memory 1004 may store an operating system and an application program. When the technical solutions provided in the embodiments of the present disclosure are implemented using software or firmware, program code used to implement the technical solutions provided in the embodiments of the present disclosure is saved in the memory 1004, and is executed by the processor 1002.

The communications interface 1006 uses, for example, but is not limited to a transceiver apparatus such as a transceiver, to implement communication with another device or a communications network.

The bus 1008 may include a path that transmits information between the components (such as the processor 1002, the memory 1004, and the communications interface 1006).

When an access device includes the general-purpose computer structure 1000, and when the processor 1002 invokes an instruction in the memory 1004, following is included. Controlling, by the processor 1002, the communications interface 1006 to send a traffic volume request to a charging device, controlling, by the processor 1002, the communications interface 1006 to receive information about a granted traffic volume that is returned by the charging device according to the traffic volume request, and controlling, by the processor 1002, the communications interface 1006 to send a charging request to the charging device according to usage of the granted traffic volume by the end user, where the charging request carries a parameter indicating linear traffic information such that the charging device performs charging according to the linear traffic information, where the linear traffic information is a parameter related to each phase of linear traffic generated during a process in which the end user uses the granted traffic volume.

When a charging device includes the general-purpose computer structure 1000, and when the processor 1002 invokes an instruction in the memory 1004, following is included. Controlling, by the processor 1002, the communications interface 1006 to receive a traffic volume request sent by an access device, controlling, by the processor 1002, the communications interface 1006 to return information about a granted traffic volume to the access device according to the traffic volume request, controlling, by the processor 1002, the communications interface 1006 to receive a charging request sent by the access device, where the charging request carries a parameter indicating linear traffic information, where the linear traffic information is a parameter related to each phase of linear traffic generated during a process in which the end user uses the granted traffic volume, and performing, by the processor 1002, charging according to the linear traffic information.

It should be noted that, although the general-purpose computer structure 1000 shown in FIG. 10 shows only the processor 1002, the memory 1004, the communications interface 1006, and the bus 1008, in a specific implementation process, persons skilled in the art should understand that the foregoing access device and charging device further include another component required in normal running. In addition, according to a specific need, persons skilled in the art should understand that the foregoing access device and charging device may further include a hardware component implementing another additional function. In addition, persons skilled in the art should understand that the foregoing access device and charging device may alternatively include only a component required for implementing this embodiment of the present disclosure, and do not need to include all components shown in FIG. 10.

Persons of ordinary skill in the art may understand that all or some of the steps of the foregoing methods may be implemented by a program instructing relevant hardware. The program may be stored in a computer readable storage medium. The storage medium includes a ROM, a RAM, an optical disc, and the like.

To sum up, the foregoing descriptions are merely exemplary embodiments of the present disclosure, and are not intended to limit the protection scope of the present disclosure. Any modification, equivalent replacement, or improvement made without departing from the spirit and principle of the present disclosure shall fall within the protection scope of the present disclosure.

What is claimed is:

1. An access device, comprising:
a processor;
a communications interface; and
a memory coupled to the processor and configured to store programming instructions for execution by the processor, wherein the programming instructions instruct the processor to control the communications interface to:
send a traffic volume request to a charging device;
receive information about a granted traffic volume that is returned by the charging device according to the traffic volume request; and
send a charging request to the charging device according to usage of the granted traffic volume by an end user, wherein the charging request carries a parameter indicating linear traffic information such that the charging device performs charging according to the linear traffic information, and wherein the linear traffic information is a parameter related to each phase of linear traffic generated when the end user uses the granted traffic volume.

2. The access device according to claim 1, wherein the linear traffic information comprises a volume of each phase of linear traffic, a time point when each phase of linear traffic starts to be generated, and a duration of each phase of linear traffic.

3. The access device according to claim 1, wherein the linear traffic information comprises a bit rate of each phase of linear traffic, a time point when each phase of linear traffic starts to be generated, and a duration of each phase of linear traffic.

4. The access device according to claim 2, wherein when obtaining the linear traffic volume, the processor is further configured to:
set a timer;
configure a timing duration; and
acquire a used traffic volume when a traffic use duration reaches the timing duration.

5. The access device according to claim 3, wherein when obtaining the linear traffic bit rate, the processor is further configured to:
configure a timer and a timing duration;
acquire a used traffic volume when a traffic use duration reaches the timing duration; and
determine the linear traffic bit rate according to the used traffic volume and the timing duration.

6. The access device according to claim 1, wherein the traffic volume request and the charging request are credit control request (CCR) messages, wherein the information about the granted traffic volume is carried in a credit control answer (CCA) message, and wherein the parameter indicating linear traffic information is carried in an extension field in a CCR message.

7. The access device according to claim 1, wherein the traffic volume request and the charging request are credit control request (CCR) messages, wherein the information about the granted traffic volume is carried in a credit control answer (CCA) message, and wherein the parameter indicating linear traffic information is carried in a reserved field in a CCR message.

8. A charging device, comprising:
a processor;
a communications interface; and
a memory coupled to the processor and configured to store programming instructions for execution by the processor, wherein the programming instructions instruct the processor to control the communications interface to:
receive a traffic volume request sent by an access device;
return information about a granted traffic volume to the access device according to the traffic volume request;
receive a charging request sent by the access device, wherein the charging request carries a parameter indicating linear traffic information, and wherein the linear traffic information is a parameter related to each phase of linear traffic generated when an end user uses the granted traffic volume; and
perform charging according to the linear traffic information.

9. The charging device according to claim 8, wherein the linear traffic information comprises a volume of each phase of linear traffic, a time point when each phase of linear traffic starts to be generated, and a duration of each phase of linear traffic.

10. The charging device according to claim 8, wherein the linear traffic information comprises a bit rate of each phase of linear traffic, a time point when each phase of linear traffic starts to be generated, and a duration of each phase of linear traffic.

11. The charging device according to claim 8, wherein performing charging comprises re-rating traffic.

12. The charging device according to claim 8, wherein the charging request is a credit control request (CCR) message, and wherein the parameter indicating the linear traffic information is carried in an extension field in the CCR message.

13. The charging device according to claim 8, wherein the charging request is a credit control request (CCR) message, and wherein the parameter indicating the linear traffic information is carried in a reserved field in the CCR message.

14. A charging system, comprising:
an access device configured to:
send a traffic volume request to a charging device;
receive information about a granted traffic volume that is returned by the charging device according to the traffic volume request; and
send a charging request to the charging device according to usage of the granted traffic volume by an end user, wherein the charging request carries a parameter indicating linear traffic information such that the charging device performs charging according to the linear traffic information, and wherein the linear traffic information is a parameter related to each phase of linear traffic generated when the end user uses the granted traffic volume; and
the charging device coupled to the access device and configured to:
receive the traffic volume request sent by the access device;
return the information about the granted traffic volume to the access device according to the traffic volume request;
receive the charging request sent by the access device, wherein the charging request carries the parameter indicating linear traffic information; and
perform charging according to the linear traffic information.
